(19) United States
(12) Patent Application Publication
(10) Pub. No.: US 2015/0025894 A1
(43) Pub. Date: Jan. 22, 2015

(54) METHOD FOR ENCODING AND DECODING OF MULTI CHANNEL AUDIO SIGNAL, ENCODER AND DECODER

(71) Applicant: Electronics and Telecommunications Research Institute, Daejeon (KR)

(72) Inventors: Yong Ju LEE, Daejeon (KR); Jeong Il SEO, Daejeon (KR); Jae Hyoun YOO, Daejeon (KR); Kyeong Ok KANG, Daejeon (KR); Jin Woong KIM, Daejeon (KR); Seung Kwon BEACK, Seoul (KR); Jong Mo SUNG, Daejeon (KR); Tae Jin LEE, Daejeon (KR)

(21) Appl. No.: 14/333,092

(22) Filed: Jul. 16, 2014

(30) Foreign Application Priority Data
Jul. 16, 2013 (KR) 10-2013-0083312
Jul. 16, 2014 (KR) 10-2014-0089722

(51) Int. Cl. G10L 19/008; G10L 19/002

(52) U.S. Cl. CPC G10L 19/008; G10L 19/002
USPC 704/500

(57) ABSTRACT

Provided are a method of encoding and decoding a multichannel audio signal, and an encoder and a decoder to perform the method. The present invention may perform encoding into consideration of a size of bit to be allocated based on a feature of audio signal for each channel with respect to an audio signal having a plurality of channels, thereby enhancing an encoding efficiency of the multichannel audio signal.

### TECHNICAL FIELD

The present invention relates to a method of encoding and decoding a multichannel audio signal having a plurality of channels, and an encoder and a decoder to perform the method, and more particularly, to a method and apparatus for allocating, for each channel, a different bitrate based on an audio frame.

### BACKGROUND ART

Currently, with the enhancement in the quality of multimedia content, content including a multichannel audio signal having a relatively large number of channels compared to a 5.1-channel audio signal, such as a 7.1-channel audio signal, a 10.2-channel audio signal, a 13.2-channel audio signal, and a 22.2-channel audio signal greater has been generated. For example, there have been attempts to use a multichannel audio signal such as a 13.2-channel audio signal in the movie field, and to use a multichannel audio signal such as a 10.2-channel audio signal and a 22.2-channel audio signal in a high quality broadcasting field such as an ultra high definition television (UHD TV).

As described above, a multichannel audio signal represents a large capacity and thus, it is important to efficiently encode the multichannel audio signal. In audio encoding technology according to the related art, the same bitrate is allocated for each channel, or encoding is performed over the entire section of a channel-by-channel audio signal at nearly constant bitrates.

In another audio encoding technology according to the related art, an audio may be encoded using a variable bitrate (VBR). However, such encoding technology may achieve a relatively excellent encoding efficiency due to an insignificant signal difference for each channel with respect to an audio signal having a relatively small number of channels, however, may show a relatively poor encoding efficiency due to a significant signal difference for each channel with respect to a multichannel audio signal such as a 10.2-channel audio signal and a 22.2-channel audio signal.

Accordingly, there is a need for a method capable of further effectively encoding a multichannel audio signal.

### DESCRIPTION OF INVENTION

### Subjects

The present invention provides a method and apparatus for allocating a different bitrate to each channel when encoding a multichannel audio signal.

The present invention also provides a method and apparatus for providing a multichannel audio signal having a high sound quality even in the same bitrate environment.

### Solutions

According to an aspect of the present invention, there is provided an encoding method including: extracting a feature of audio signal for each channel with respect to an audio signal having a plurality of channels; allocating a size of bit required to encode audio signal for each channel based on the extracted feature of audio signal; and encoding the audio signal having a plurality of channels for each channel based on the size of bit.

The extracting a feature of audio signal for each channel may include extracting energy for each channel with respect to each of a plurality of frames constituting the audio signal.

The allocating the size of the bit may include allocating the size of bit to be allocated for each channel, based on the extracted energy for each channel.

The allocating of the size of bit may include allocating the size of bit to be proportional to an intensity of the extracted energy for each channel.

The allocating of the size of bit may include allocating the size of bit equally or unequally for each channel with respect to each of a plurality of frames constituting the audio signal.

The encoding the audio signal may include encoding the audio signal having the plurality of channels by using a plurality of encoding units to encode an audio signal of mono channel or an audio signal of stereo channel.

The encoding method may further include generating a bitstream by multiplexing the encoded audio signal.

According to another aspect of the present invention, there is provided a decoding method including: extracting an encoded audio signal from a bitstream; and decoding the audio signal based on a size of bit allocated for each channel of the encoded audio signal.

The decoding may include decoding encoded audio signal by using a plurality of decoding units to decode an audio signal of mono channel or an audio signal of stereo channel.

The size of bit allocated for each channel is determined for each channel, based on the extracted energy for each channel of the encoded audio signal.

According to still another aspect of the present invention, there is provided an encoder including: a channel feature extractor configured to extract a feature of audio signal for each channel with respect to an audio signal having a plurality of channels; a bit size allocator configured to allocate a size of bit required to encode audio signal for each channel based on the extracted feature of audio signal; and a plurality of encoding units each configured to encode the audio signal having a plurality of channels for each channel based on the size of bit.

The channel feature extractor may extract energy for each channel with respect to each of a plurality of frames constituting the audio signal.

The bit size allocator may allocate the size of bit to be allocated for each channel, based on the extracted energy for each channel.

The bit size allocator may allocate the size of bit to be proportional to an intensity of the extracted energy for each channel.

The bit size allocator may allocate the size of bit equally or unequally for each channel with respect to each of a plurality of frames constituting the audio signal.

Each of the plurality of encoding units may encode an audio signal of mono channel or an audio signal of stereo channel.

The encoder may further include a bitstream generator configured to generate a bitstream by multiplexing the encoded audio signal.

According to still another aspect of the present invention, there is provided a decoder including: a bitstream analyzer configured to extract an encoded audio signal from a bitstream; and a plurality of decoding units each configured to decode the audio signal based on a size of bit allocated for each channel of the encoded audio signal.

Each of the plurality of decoding units may decode an audio signal of mono channel or an audio signal of stereo channel.

The size of bit allocated for each channel may be determined for each channel, based on the extracted energy for each channel of the encoded audio signal

### Effects of the Invention

According to embodiments of the present invention, it is possible to enhance an encoding efficiency by allocating a different bitrate to each channel when encoding a multichannel audio signal.

Also, according to embodiments of the present invention, it is possible to provide a multichannel audio signal having a high quality even in the same bitrate environment.

Also, according to embodiments of the present invention, it is possible to play back a high quality audio signal at a playback terminal including a decoder by further efficiently encoding a multichannel audio signal.

### BRIEF DESCRIPTION OF DRAWINGS

FIG. 1 is a block diagram illustrating an encoder and a decoder according to an embodiment.

FIG. 2 is a block diagram illustrating a configuration of an encoder according to an embodiment.

FIG. 3 is a flowchart illustrating an operation method of an encoder according to an embodiment.

FIG. 4 illustrates a size of bit for each channel according to an embodiment.

FIG. 5 is a block diagram illustrating a configuration of a decoder according to an embodiment.

FIG. 6 is a flowchart illustrating an operation method of a decoder according to an embodiment.

### DETAILED DESCRIPTION TO CARRY OUT THE INVENTION

Hereinafter, embodiments of the present invention will be described with reference to the accompanying drawings.

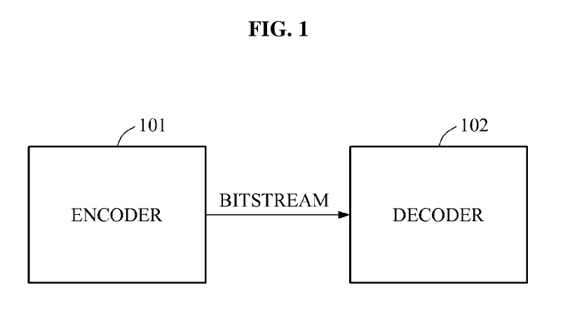

FIG. 1 is a block diagram illustrating an encoder and a decoder according to an embodiment.

Referring to FIG. 1, an encoder 101 and a decoder 102 are illustrated. The encoder 101 may generate a bitstream by encoding a multichannel audio signal. The decoder 102 may decode the multichannel audio signal from the bitstream.

The encoder 101 may encode the multichannel audio signal constituting audio signals corresponding to a plurality of channels, using a plurality of encoding units configured to independently perform encoding. Here, the encoder 101 may allocate a different size of bit for each channel per frame. That is, the encoder 101 may variably allocate a size of bit per each frame included in the audio signal for each channel of multichannel audio signal. In this instance, each of the plurality of encoding units may perform encoding into consideration of a size of bit allocated based on a feature of audio signal for each channel.

Here, the feature of audio signal indicates a feature of audio signal for each channel constituting multichannel audio signal. For example, the feature may include a intensity of energy corresponding to a frame of audio signal for each channel. The size of bit may indicate the number of bits required for encoding. That is, the encoder 101 may variably allocate the size of bit based on the feature, thereby maintaining the quality of the multichannel audio signal and further efficiently performing encoding.

The decoder 102 may decode, from the bitstream, the multichannel audio signal having the plurality of channels, using a plurality of decoding units configured to independently perform decoding. Here, each of the plurality of decoding units may perform decoding based on the feature determined by the encoder 101.

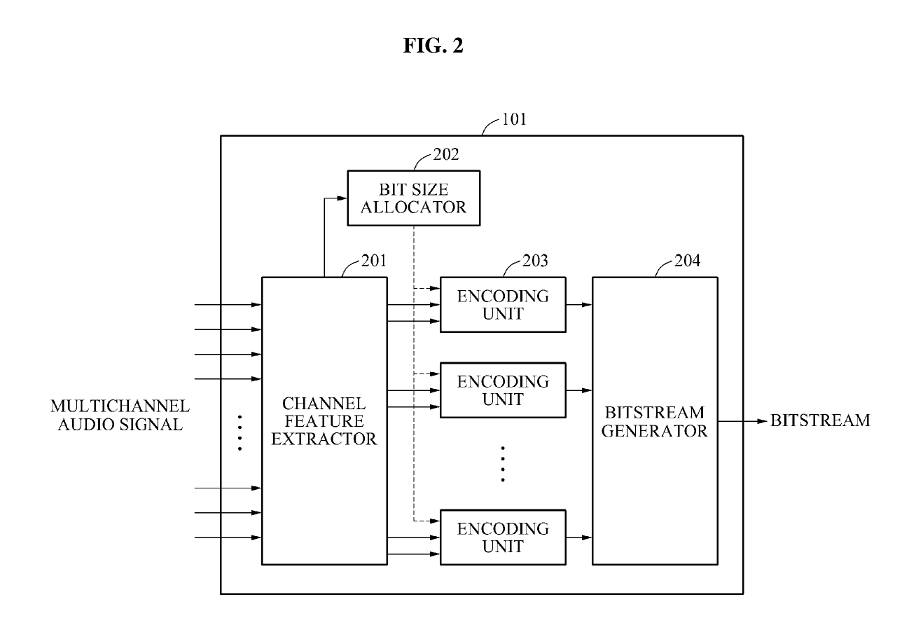

FIG. 2 is a block diagram illustrating a configuration of an encoder according to an embodiment.

Referring to FIG. 2, the encoder 101 may include a channel feature extractor 201, a bit size allocator 202, a plurality of encoding units 203, and a bitstream generator 204.

The channel feature extractor 201 may extract, a feature of audio signal for each channel of a multichannel audio signal having a plurality of channels. In detail, the channel feature extractor 201 may extract, the feature of audio signal for each channel constituting the multichannel audio signal. That is, the channel feature extractor 201 may extract the feature of a plurality of frames of the multichannel audio signal for each channel of the plurality of channels.

Here, a frame may be divided based on a time section of an audio signal. As an example, a feature of audio signal for each channel may indicate an intensity of energy of a frame included in an audio signal corresponding to each channel. In detail, when an audio signal corresponding to channel 1 and channel 2 includes N frames, the channel feature extractor 201 may determine energy of each of the N frames for each of channel 1 and channel 2. The intensity of energy corresponding to each of the N frames may differ for each of channel 1 and channel 2.

The bit size allocator 202 may allocate a size of bit for each channel based on the feature of the audio signal. Here, the size of bit may indicate the number of bits required to encode frames included in an audio signal for each channel. According to an increase in the size of bit, the number of bits may also increase and accordingly, a bitrate may also increase.

In detail, the bit size allocator 202 may determine an output bit of each channel based on a per-time section feature of the audio signal. Here, an output bitrate corresponding to each channel may be determined based on a frame unit or a multiple unit of a frame. Also, when adding up bits for each channel based on the frame unit, frames may show the same or similar result with respect to each other.

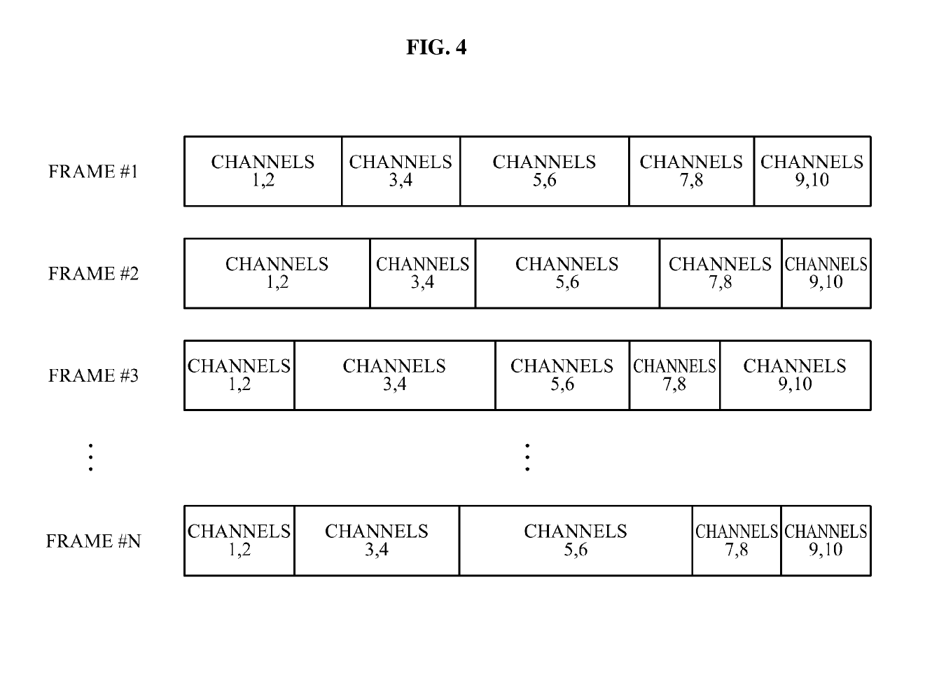

As an example, even with respect to frames corresponding to the same order in the multichannel audio signal, the bit size allocator 202 may differently allocate a size of bit required when encoding the multichannel audio signal. For example, a size of bit to be allocated to a frame 1 included in an audio signal of channel 1 may differ from a size of bit to be allocated to a frame 1 included in an audio signal of channel 2. However, when adding up sizes of bit allocated for the respective channels with respect to frames of the multichannel audio signal, the sum may be the same or similar for each frame. It will be further described with reference to FIG. 4.

The bit size allocator 202 may allocate differently a size of bit for each channel with respect to each of frames. For example, a relatively large size of bit for encoding may be allocated to a channel indicating a relatively large intensity of energy. And, a relatively small size of bit for encoding may be allocated to a channel having no audio signal or indicating a relatively small intensity of energy.

Each of the plurality of encoding units 203 may encode an audio signal corresponding to a single channel (mono) or two channels (stereo) with respect to the multichannel audio signal, based on the size of bit allocated for each channel. Each of the plurality of encoding units 203 of FIG. 2 encodes and thereby down-mixes an audio signal corresponding to two channels to an audio signal corresponding to a single channel. The encoding units 203 corresponding to the respective channels may perform encoding independently with respect to each other.

An encoding result of the plurality of encoding units 203 may be multiplexed by the bitstream generator 204 to generate a single bitstream.

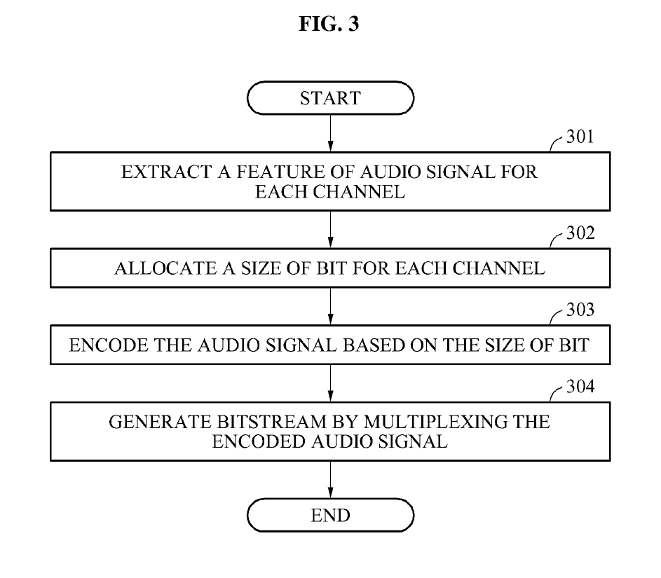

FIG. 3 is a flowchart illustrating an operation method of an encoder according to an embodiment.

In operation 301, the encoder may extract a feature of an audio signal for each channel. Here, a feature of the audio signal refers to a feature for each frame corresponding to a time section of a multichannel audio signal and may be determined to be the equally or unequally for each channel. The feature of the audio signal may indicate energy of frames included in an audio signal corresponding to each channel.

In operation 302, the encoder 101 may allocate a size of bit to be allocated for each channel based on the extracted feature. In detail, the encoder 101 may increase the size of bit required to encode a frame, according to an increase in intensity of energy with respect to a frame corresponding to the extracted feature. Here, the size of bit may indicate the number of bits required for encoding.

In operation 303, the encoder 101 may encode audio signal based on the size of bit allocated for each channel. Here, the encoder 101 may independently encode the respective multichannel audio signals using a plurality of encoding units. Here, the multichannel audio signal having the plurality of channels may be eoncoded based on a plurality of encoding units to encode an audio signal of mono channel or an audio signal of stereo channel.

In operation 304, the encoder 101 may generate a bitstream by multiplexing audio signals encoded for the respective channels.

FIG. 4 illustrates a size of bit for each channel according to an embodiment.

Referring to FIG. 4, a multichannel audio signal includes a plurality of audio signals corresponding to ten channels from channel 1 to channel 10. Here, it is assumed that a plurality of encoding units audio signal of stereo channel by coupling audio signals. An audio signal corresponding to each channel includes frame 1 to frame N. Here, a size of bit for each channel within a single frame may be the same or different. A size of bit for each channel included in each frame may be the same as or different from a size of bit of a previous frame. The size of bit for each channel is determined equally or unequally based on intensity of energy for each channel with respect to a frame.

For example, a size (bits) of bit allocated to channels 1 and 2 may differ from a size (bits) of bit allocated to channels 3 and 4. Meanwhile, even in the case of the same channels 1 and 2, a size of bit to be allocated to the frame 1 and a size of bit to be allocated to the frame 2 may differ. Here, a size of bit to be allocated for each channel is associated with energy determined for each channel with respect to a frame divided based on a time section of a multichannel audio signal. In detail, a size of bit allocated when performing encoding may be associated with a intensity of energy determined in a predetermined frame. In FIG. 4, a size of bit corresponds to a length of each block.

Referring to FIG. 4, a size of bit for each channel allocated with respect to each frame may be determined based on a feature for each channel. In this case, even within the same frame, a size of bit for each channel may be the same or different. Also, even in the case of the same channel, a size of bit allocated with respect to each frame may be the same or different.

In FIG. 4, it is assumed that the plurality of encoding units performs encoding by coupling two channels and thus, a size of bit allocated to the respective two channels to be encoded with respect to a predetermined frame may be allocate to be the same. When the plurality of encoding units encodes an audio signal corresponding to a single channel in a monotype, a size of bit to be allocated to channel 1 may differ from a size of bit to be allocated to channel 2. That is, in the case of a single frame, a size of bit to be divided based on ten channels may be allocated to encode the corresponding frame.

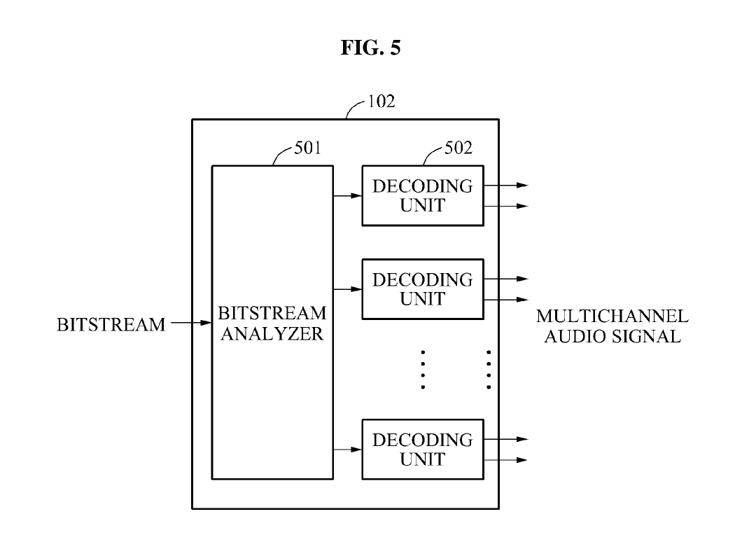

FIG. 5 is a block diagram illustrating a configuration of a decoder according to an embodiment.

Referring to FIG. 5, the decoder 102 may include a bitstream analyzer 501 and a plurality of decoding units 502.

The bitstream analyzer 501 may extract a target to be decoded by analyzing a bitstream generated by the encoder 101. In detail, the bitstream analyzer 501 may extract, from the bitstream, an encoded multichannel audio signal and a size of bit allocated for each channel by de-multiplexing the bitstream.

Each of the plurality of decoding units 502 may decode the encoded multichannel audio signal based on the size of bit allocated for each channel. Accordingly, an original multichannel audio signal may be decoded.

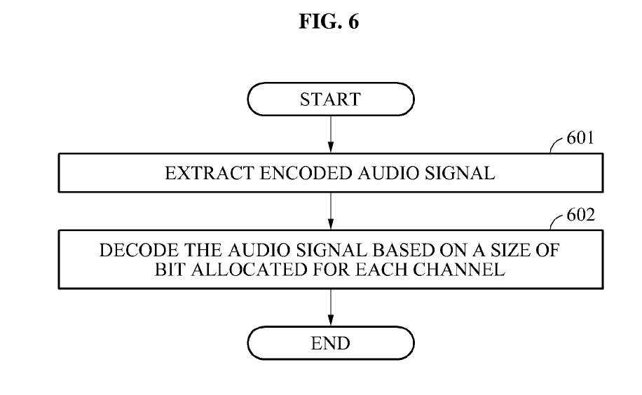

FIG. 6 is a flowchart illustrating an operation method of a decoder according to an embodiment.

In operation 601, the decoder 102 may extract an encoded multichannel audio signal from a bitstream. The decoder 102 may extract, from the bitstream, a size of bit allocated for each channel used when encoding the multichannel audio signal.

In operation 602, the decoder 102 may decode the encoded audio signal based on the size of bit allocated for each channel, using a plurality of decoding units. An original multichannel audio signal may be decoded based on a decoding result.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### EXPLANATION OF SYMBOLS

101: encoder
102: decoder

What is claimed is:

1. An encoding method, comprising:
extracting a feature of audio signal for each channel with respect to multichannel audio signal constituting audio signals corresponding to a plurality of channels;
allocating a size of bit required to encode audio signal for each channel based on the extracted feature of audio signal; and
encoding the audio signal having a plurality of channels for each channel based on the size of bit.

2. The encoding method of claim 1, wherein the extracting a feature of audio signal for each channel comprising:
extracting energy for each channel with respect to each of a plurality of frames constituting the audio signal, and
wherein the allocating the size of the bit comprising:
allocating the size of bit to be allocated for each channel, based on the extracted energy for each channel.

3. The encoding method of claim 2, wherein the allocating of the size of bit comprises:
allocating the size of bit to be proportional to an intensity of the extracted energy for each channel.

4. The encoding method of claim 1, wherein the allocating of the size of bit comprises:
allocating the size of bit equally or unequally for each channel with respect to each of a plurality of frames constituting the audio signal.

5. The encoding method of claim 1, wherein the encoding the audio signal comprises encoding the audio signal having the plurality of channels by using a plurality of encoding units to encode an audio signal of mono channel or an audio signal of stereo channel.

6. The encoding method of claim 1, further comprising:
generating a bitstream by multiplexing the encoded audio signal.

7. A decoding method, comprising:
extracting an encoded audio signal from a bitstream; and
decoding the audio signal based on a size of bit allocated for each channel of the encoded audio signal.

8. The decoding method of claim 7, wherein the decoding comprises decoding encoded audio signal by using a plurality of decoding units to decode an audio signal of mono channel or an audio signal of stereo channel.

9. The decoding method of claim 7, wherein the size of bit is determined for each channel, based on the extracted energy for each channel of the encoded audio signal.

10. An encoder, comprising:
a channel feature extractor configured to extract a feature of audio signal for each channel with respect to multichannel audio signal constituting audio signals corresponding to a plurality of channels;
a bit size allocator configured to allocate a size of bit required to encode audio signal for each channel based on the extracted feature of audio signal; and
a plurality of encoding units each configured to encode the audio signal having a plurality of channels for each channel based on the size of bit.

11. The encoder of claim 10, wherein
the channel feature extractor is configured to extract energy for each channel with respect to each of a plurality of frames constituting the audio signal, and
the bit size allocator is configured to allocate the size of bit to be allocated for each channel, based on the extracted energy for each channel.

12. The encoder of claim 11, wherein the bit size allocator is configured to allocate the size of bit to be proportional to an intensity of the extracted energy for each channel.

13. The encoder of claim 10, wherein the bit size allocator is configured to allocate the size of bit equally or unequally for each channel with respect to each of a plurality of frames constituting the audio signal.

14. The encoder of claim 10, wherein each of the plurality of encoding units configured to encode an audio signal of mono channel or an audio signal of stereo channel.

15. The encoder of claim 10, further comprising:
a bitstream generator configured to generate a bitstream by multiplexing the encoded audio signal.
